(19) United States
(12) Patent Application Publication
(10) Pub. No.: US 2017/0358257 A1
(43) Pub. Date: Dec. 14, 2017

(54) LIGHT EMITTING CIRCUIT, DISPLAY DEVICE, AND PIXEL

(71) Applicant: MIKRO MESA TECHNOLOGY CO., LTD., APIA (WS)

(72) Inventors: Shih-Chyn LIN, Tainan City (TW); Li-Yi CHEN, Tainan City (TW)

(21) Appl. No.: 15/180,076

(22) Filed: Jun. 12, 2016

(51) Int. Cl. G09G 3/32

(52) U.S. Cl. CPC G09G 3/32; G09G 2300/0452; G09G 2300/0819; G09G 2330/021

(57) ABSTRACT

A pixel includes a first driving transistor, a first control circuit, a second driving transistor, and a second control circuit. The first driving transistor is configured to drive a first light emitting diode according to a first driving signal and a first supply voltage from a first voltage supply. The first control circuit is configured to generate the first driving signal according to a first data voltage and a scan signal. The second driving transistor is configured to drive a second light emitting diode according to a second driving signal and a second supply voltage from a second voltage supply. The second control circuit is configured to generate the second driving signal according to a second data and the scan signal. The first supply voltage and the second supply voltage are different from each other.

### BACKGROUND

### Technical Field

The present disclosure relates to a circuit, an electronic device, and an electronic component. More particularly, the present disclosure relates to a light emitting circuit, a display device, and a pixel.

### Description of Related Art

With advances in electronic technology, display devices are being increasingly used.

A typical display device includes a scan circuit, a data circuit, and a pixel array with pixel circuits. Each of the pixel circuits in the pixel array includes a driving transistor, a switching transistor and a light emitting diode. The scan circuit can sequentially generate a plurality of scan signals, and provide the scan signals to scan lines, so as to sequentially turn on the switching transistors of the pixel circuits. The data circuit can generate a plurality of data signals and provide the data signals to the driving transistors via the switching transistors which turn on, so as to enable the driving transistors to drive the light emitting diodes according to the data signals. With such operation, the light emitting diodes in the display device are able to emit light and display images.

### SUMMARY

One aspect of the present disclosure is related to a light emitting circuit. In accordance with one embodiment of the present disclosure, the light emitting circuit includes a first light emitting diode, a first driving transistor, a first control circuit, a second light emitting diode, a second driving transistor, a second control circuit, a third light emitting diode, a third driving transistor, and a third control circuit. The first driving transistor is serially and electrically connected with a first voltage supply having a first supply voltage and the first light emitting diode. The first control circuit is electrically connected to the first driving transistor, configured to drive the first driving transistor according to a first data voltage and a scan signal. The second driving transistor is serially and electrically connected with a second voltage supply having a second supply voltage and the second light emitting diode. The second control circuit is electrically connected to the second driving transistor, configured to drive the second driving transistor according to a second data voltage and the scan signal. The third driving transistor is serially and electrically connected with a third voltage supply having a third supply voltage and the third light emitting diode. The third control circuit is electrically connected to the third driving transistor, configured to drive the third driving transistor according to a third data voltage and the scan signal. At least two of the first supply voltage, the second supply voltage, and the third supply voltage are different from each other.

In accordance with one embodiment of the present disclosure, at least two of threshold voltages of the first light emitting diode, the second light emitting diode, and the third light emitting diode are different from each other.

In accordance with one embodiment of the present disclosure, the first light emitting diode is a red light emitting diode, the second light emitting diode is a green light emitting diode, the third light emitting diode is a blue light emitting diode, the second supply voltage is greater than the first supply voltage, and the third supply voltage is greater than the second supply voltage.

In accordance with one embodiment of the present disclosure, the threshold voltage of the second light emitting diode is greater than the threshold voltage of the first light emitting diode, and the threshold voltage of the third light emitting diode is greater than the threshold voltage of the second light emitting diode.

In accordance with one embodiment of the present disclosure, the first light emitting diode is a red light emitting diode, the second light emitting diode is a green light emitting diode, the third light emitting diode is a blue light emitting diode, the second supply voltage is greater than the first supply voltage, and the third supply voltage is equal to the second supply voltage.

In accordance with one embodiment of the present disclosure, the threshold voltage of the second light emitting diode is greater than the threshold voltage of the first light emitting diode, and the threshold voltage of the third light emitting diode is substantially equal to the threshold voltage of the second light emitting diode.

Another aspect of the present disclosure is related to a display device. In accordance with one embodiment of the present disclosure, the display device includes a plurality of scan lines, a plurality of data lines, and a plurality of pixels. The pixels are electrically connected to the scan lines and the data lines. The pixels include a first light emitting diode, a first driving transistor, a first control circuit, a second light emitting diode, a second driving transistor, a second control circuit, a third light emitting diode, a third driving transistor, and a third control circuit. The first driving transistor is serially and electrically connected with a first voltage supply having a first supply voltage and the first light emitting diode. The first control circuit is electrically connected to the first driving transistor, configured to drive the first driving transistor according to a first data voltage from a first data line of the data lines and a scan signal from one of the scan lines to drive the first driving circuit. The second driving transistor is serially and electrically connected with a second voltage supply having a second supply voltage and the second light emitting diode. The second control circuit electrically connected to the second driving transistor, configured to drive the second driving transistor according to a second data voltage from a second data line of the data lines and the scan signal from the one of the scan lines to drive the second driving circuit. The third driving transistor is serially and electrically connected with a third voltage supply having a third supply voltage and the third light emitting diode. The third control circuit is electrically connected to the third driving transistor, configured to drive the third driving transistor according to a third data voltage from a third data line of the data lines and the scan signal from the one of the scan lines to drive the third driving circuit. At least two of the first supply voltage, the second supply voltage, and the third supply voltage are different from each other.

In accordance with one embodiment of the present disclosure, at least two of threshold voltages of the first light emitting diode, the second light emitting diode, and the third light emitting diode are different from each other.

In accordance with one embodiment of the present disclosure, the first light emitting diode is a red light emitting diode, the second light emitting diode is a green light emitting diode, the third light emitting diode is a blue light emitting diode, the second supply voltage is greater than the first supply voltage, and the third supply voltage is greater than the second supply voltage.

In accordance with one embodiment of the present disclosure, the threshold voltage of the second light emitting diode is greater than the threshold voltage of the first light emitting diode, and the threshold voltage of the third light emitting diode is greater than the threshold voltage of the second light emitting diode.

In accordance with one embodiment of the present disclosure, the first light emitting diode is a red light emitting diode, the second light emitting diode is a green light emitting diode, the third light emitting diode is a blue light emitting diode, the second supply voltage is greater than the first supply voltage, and the third supply voltage is equal to the second supply voltage.

In accordance with one embodiment of the present disclosure, the threshold voltage of the second light emitting diode is greater than the threshold voltage of the first light emitting diode, and the threshold voltage of the third light emitting diode is substantially equal to the threshold voltage of the second light emitting diode.

Another aspect of the present disclosure is related to a pixel. In accordance with one embodiment of the present disclosure, the pixel includes a first driving transistor, a first control circuit, a second driving transistor, and a second control circuit. The first driving transistor is configured to drive a first light emitting diode according to a first driving signal and a first supply voltage from a first voltage supply. The first control circuit is configured to generate the first driving signal according to a first data voltage and a scan signal. The second driving transistor is configured to drive a second light emitting diode according to a second driving signal and a second supply voltage from a second voltage supply. The second control circuit is configured to generate the second driving signal according to a second data voltage and the scan signal. The first supply voltage and the second supply voltage are different from each other.

In accordance with one embodiment of the present disclosure, threshold voltages of the first light emitting diode and the second light emitting diode are different.

In accordance with one embodiment of the present disclosure, the first light emitting diode is a red light emitting diode, the second light emitting diode is a green light emitting diode or a blue light emitting diode, and the second supply voltage is greater than the first supply voltage.

In accordance with one embodiment of the present disclosure, the first light emitting diode is a green light emitting diode, the second light emitting diode is a blue light emitting diode, and the second supply voltage is greater than the first supply voltage.

In accordance with one embodiment of the present disclosure, the pixel further includes a third driving transistor and a third control circuit. The third driving transistor is configured to drive a third light emitting diode according to a third driving signal and a third supply voltage from a third voltage supply. The third control circuit is configured to generate the third driving signal according to a third data voltage and the scan signal. The third supply voltage is different from the first supply voltage and the second supply voltage.

In accordance with one embodiment of the present disclosure, the pixel further includes a third driving transistor and a third control circuit. The third driving transistor is configured to drive a third light emitting diode according to a third driving signal and the second supply voltage from the second voltage supply. The third control circuit is configured to generate the third driving signal according to a third data voltage and the scan signal.

In accordance with one embodiment of the present disclosure, the pixel further includes a fourth driving transistor and a fourth control circuit. The fourth driving transistor is configured to drive a fourth light emitting diode according to a fourth driving signal and the first supply voltage from the first voltage supply. The fourth control circuit is configured to generate the fourth driving signal according to a fourth data voltage and the scan signal.

In accordance with one embodiment of the present disclosure, the pixel further includes a fourth driving transistor and a fourth control circuit. The fourth driving transistor is configured to drive a fourth light emitting diode according to a fourth driving signal and the second supply voltage from the second voltage supply. The fourth control circuit is configured to generate the fourth driving signal according to a fourth data voltage and the scan signal.

In accordance with one embodiment of the present disclosure, the pixel further includes a fifth driving transistor and a fifth control circuit. The fifth driving transistor is configured to drive a fifth light emitting diode according to a fifth driving signal and the first supply voltage from the first voltage supply. The fifth control circuit is configured to generate the fifth driving signal according to a fifth data voltage and the scan signal.

In accordance with one embodiment of the present disclosure, the pixel further includes a fifth driving transistor and a fifth control circuit. The fifth driving transistor is configured to drive a fifth light emitting diode according to a fifth driving signal and the second supply voltage from the second voltage supply. The fifth control circuit is configured to generate the fifth driving signal according to a fifth data voltage and the scan signal.

Through an application of one embodiment described above, the power consumption of the display device can be decreased.

### BRIEF DESCRIPTION OF THE DRAWINGS

The invention can be more fully understood by reading the following detailed description of the embodiment, with reference made to the accompanying drawings as follows:

FIG. 1 is a schematic diagram of a display device in accordance with one embodiment of the present disclosure.

FIG. 2 is a schematic diagram of a pixel circuit in accordance with one embodiment of the present disclosure.

FIG. 3 illustrates relationships between forward voltages and driving currents of different light emitting diodes in accordance with one embodiment of the present disclosure.

FIG. 4 illustrates a control circuit in accordance with another embodiment of the present disclosure.

FIG. 5 is a schematic diagram of a pixel circuit in accordance with another embodiment of the present disclosure.

FIG. 6 illustrates relationships between forward voltages and driving currents of different light emitting diodes in accordance with one embodiment of the present disclosure.

FIG. 7 is a schematic diagram of a pixel circuit in accordance with another embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

It will be understood that, in the description herein and throughout the claims that follow, when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Moreover, “electrically connect” or “connect” can further refer to the interoperation or interaction between two or more elements.

It will be understood that, in the description herein and throughout the claims that follow, although the terms “first,” “second,” etc. may be used to describe various elements, these elements should not be limited by these terms. These terms are only used to distinguish one element from another. For example, a first element could be termed a second element, and, similarly, a second element could be termed a first element, without departing from the scope of the embodiments.

It will be understood that, in the description herein and throughout the claims that follow, the terms “comprise” or “comprising,” “include” or “including,” “have” or “having,” “contain” or “containing” and the like used herein are to be understood to be open-ended, i.e., to mean including but not limited to.

It will be understood that, in the description herein and throughout the claims that follow, the phrase “and/or” includes any and all combinations of one or more of the associated listed items.

It will be understood that, in the description herein and throughout the claims that follow, words indicating direction used in the description of the following embodiments, such as “above,” “below,” “left,” “right,” “front” and “back,” are directions as they relate to the accompanying drawings. Therefore, such words indicating direction are used for illustration and do not limit the present disclosure.

It will be understood that, in the description herein and throughout the claims that follow, unless otherwise defined, all terms (including technical and scientific terms) have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any element in a claim that does not explicitly state “means for” performing a specified function, or “step for” performing a specific function, is not to be interpreted as a “means” or “step” clause as specified in 35 U.S.C. §112(f). In particular, the use of “step of” in the claims herein is not intended to invoke the provisions of 35 U.S.C. §112(f).

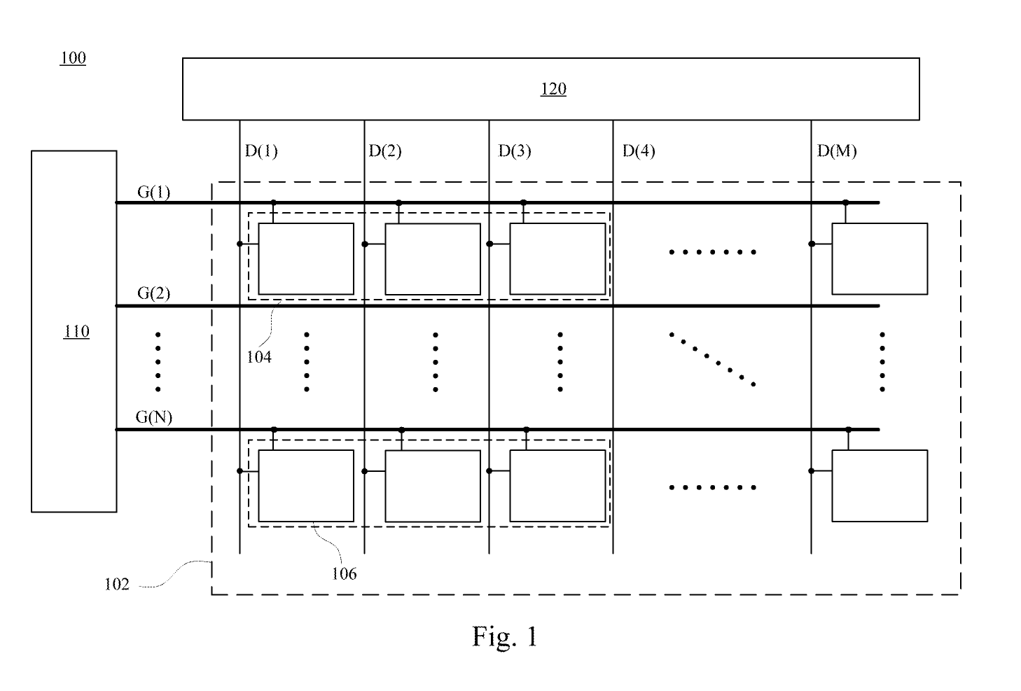

FIG. 1 is a schematic block diagram of a display device 100 in accordance with one embodiment of the present disclosure. The display device 100 includes a scan circuit 110, a data circuit 120, and a pixel array 102. The pixel array 102 may include a plurality of pixel circuits 104 arranged in a matrix. The scan circuit 110 can sequentially generate a plurality of scan signals G(1), . . . , G(N) and provide the scan signals G(1), . . . , G(N) to the pixel circuits 104 in the pixel array 102 via scan lines, so as to sequentially turn on the sub-pixel circuits 106 in the pixel circuits 104, in which N is an integer. The data circuit 120 can generate a plurality of data signals D(1), . . . , D(M) and provide the data signals D(1), . . . , D(M) to the sub-pixel circuits 106 which turn on via data lines, in which M is an integer. Through such operation, the display panel 100 can display images.

It should be noted that, in this embodiment, the number of the sub-pixel circuits in one pixel circuit is taken as an example. Another number of the sub-pixel circuits in one pixel circuit is within the contemplated scope of the present disclosure.

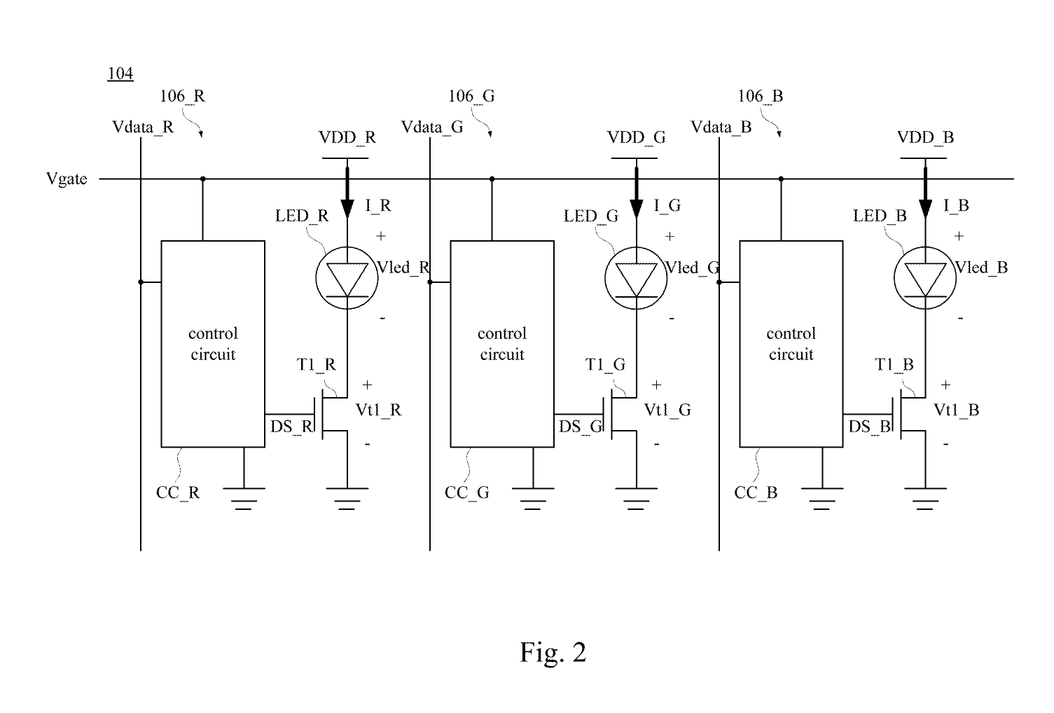

FIG. 2 is a schematic diagram of the pixel circuit 104 in accordance with one embodiment of the present disclosure. In one embodiment, the pixel circuit 104 includes sub-pixel circuits 106_R, 106_G, 106_B. The sub-pixel circuit 106_R includes a light emitting diode LED_R, a driving transistor T1_R, and a control circuit CC_R. The sub-pixel circuit 106_G includes a light emitting diode LED_G, a driving transistor T1_G, and a control circuit CC_G. The sub-pixel circuit 106_B includes a light emitting diode LED_B, a driving transistor T1_B, and a control circuit CC_B.

In one embodiment, the light emitting diode LED_R may be a red light emitting diode, the light emitting diode LED_G may be a green light emitting diode, and the light emitting diode LED_B may be a blue light emitting diode.

In one embodiment, the driving transistor T1_R is serially and electrically connected with a voltage supply having a supply voltage VDD_R and the light emitting diode LED_R. The light emitting diode LED_R is electrically connected between the voltage supply having the supply voltage VDD_R and the driving transistor T1_R. The control circuit CC_R is electrically connected to the gate of the driving transistor T1_R. The control circuit CC_R is configured to provide a driving signal DS_R to the gate of the driving transistor T1_R to drive the driving transistor T1_R according to a data voltage Vdata_R from a data line and a scan signal Vgate from a scan line. When the driving transistor T1_R is switched on, a driving current I_R passes through the light emitting diode LED_R and the driving transistor T1_R. At this time, a voltage difference Vled_R, which is substantially equal to (or slightly greater than) the threshold voltage of the light emitting diode LED_R, is presented on two end of the light emitting diode LED_R, and a voltage difference Vt1_R is presented on two end of the driving transistor T1_R.

In one embodiment, the driving transistor T1_G is serially and electrically connected with a voltage supply having a supply voltage VDD_G and the light emitting diode LED_G. The light emitting diode LED_G is electrically connected between a voltage supply having the supply voltage VDD_G and the driving transistor T1_G. The control circuit CC_G is electrically connected to the gate of the driving transistor T1_G. The control circuit CC_G is configured to provide a driving signal DS_G to the gate of the driving transistor T1_G to drive the driving transistor T1_G according to a data voltage Vdata_G from a data line and the scan signal Vgate from a scan line. When the driving transistor T1_G is switched on, a driving current I_G passes through the light emitting diode LED_G and the driving transistor T1_G. At this time, a voltage difference Vled_G, which is substantially equal to (or slightly greater than) the threshold voltage of the light emitting diode LED_G, is presented on two end of the light emitting diode LED_G, and a voltage difference Vt1_G is presented on two end of the driving transistor T1_G.

In one embodiment, the driving transistor T1_B is serially and electrically connected with a voltage supply having a supply voltage VDD_B and the light emitting diode LED_B. The light emitting diode LED_B is electrically connected between a voltage supply having the supply voltage VDD_B and the driving transistor T1_B. The control circuit CC_B is electrically connected to the gate of the driving transistor T1_B. The control circuit CC_B is configured to provide a driving signal DS_B to the gate of the driving transistor T1_B to drive the driving transistor T1_B according to a data voltage Vdata_B from a data line and a scan signal Vgate from the scan line. When the driving transistor T1_B is switched on, a driving current I_B passes through the light emitting diode LED_B and the driving transistor T1_B. At this time, a voltage difference Vled_B, which is substantially equal to (or slightly greater than) the threshold voltage of the light emitting diode LED_B, is presented on two end of the light emitting diode LED_B, and a voltage difference Vt1_B is presented on two end of the driving transistor T1_B.

In one embodiment, the data voltage Vdata_R may be one of the data signals D(1), . . . , D(M) illustrated in FIG. 1, the data voltage Vdata_G may be another one of the data signals D(1), . . . , D(M) illustrated in FIG. 1, the data voltage Vdata_B may be still another one of the data signals D(1), . . . , D(M) illustrated in FIG. 1, and the scan signal Vgate may be one of the scan signals G(1), . . . , G(N) illustrated in FIG. 1.

In one embodiment, the voltage differences Vled_R, Vled_G, Vled_B (i.e., the threshold voltages of the light emitting diodes LED_R, LED_G, LED_B) are different from each other since that the materials of the light emitting diodes LED_R, LED_G, LED_B are different.

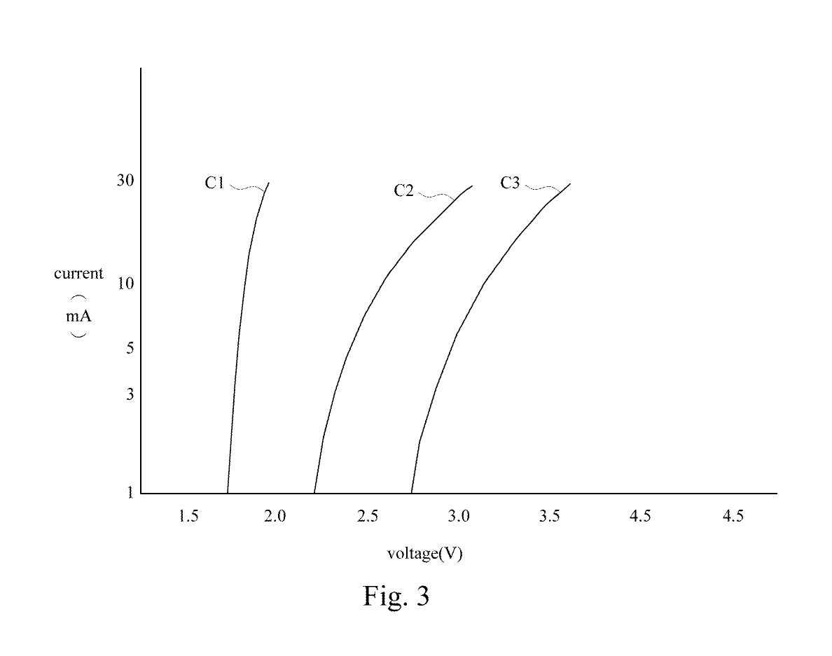

For example, FIG. 3 illustrates relationships between the forward voltages and the driving currents I_R, I_G, I_B of different light emitting diodes LED_R, LED_G, LED_B in accordance with one embodiment of the present disclosure. Curve C1 indicates the relationship between the forward voltage Vled_R and the driving current I_R, Curve C2 indicates the relationship between the forward voltage Vled_G and the driving current I_G, and Curve C3 indicates the relationship between the forward voltage Vled_B and the driving current I_B. As illustrated in FIG. 3, the threshold voltages (corresponding to the intersections between curves C1, C2, C3, and x-axis) of the light emitting diodes LED_R, LED_G, LED_B are different from each other, and therefore the voltage differences Vled_R, Vled_G, Vled_B are different from each other.

In one embodiment, at least two of the supply voltages VDD_R, VDD_G, VDD_B are different from each other, so as to decrease the voltage differences Vt1_R, Vt1_G, Vt1_B.

More particularly, in one embodiment, when the threshold voltage of the light emitting diode LED_R is lower than the threshold voltage of the light emitting diodes LED_G, and the threshold voltage of the light emitting diode LED_G is lower than the threshold voltage of the light emitting diodes LED_B, the supply voltage VDD_R is lower than the supply voltage VDD_G, and the supply voltage VDD_G is lower than the supply voltage VDD_B.

With such a configuration, the power loss on the driving transistors T1_R, T1_G, T1_B can be reduced.

In some approaches, the supply voltages are identical to each other, so that it is not possible to set one of the supply voltages according to a threshold voltage of a corresponding one light emitting diode.

However, in one embodiment of the present disclosure, the supply voltages VDD_R, VDD_G, VDD_B are different from each other and varied according to the threshold voltages of the light emitting diodes LED_R, LED_G, LED_B. Therefore, the voltage differences Vt1_R, Vt1_G, Vt1_B is able to be decreased, and the power loss on the driving transistors T1_R, T1_G, T1_B is able to be reduced.

Table 1 illustrates an illustrative example that the supply voltages are identical to each other.

| | | Threshold | | |
|---|---|---|---|---|
| | VDD | voltage | Vt1 | PTFT/Ptotal |
| LED_R | 5 V | 1.8 V | 3.2 V | 64% |
| LED_G | 5 V | 2.2 V | 2.8 V | 56% |
| LED_B | 5 V | 2.7 V | 2.3 V | 46% |

In this example, the supply voltage VDD_R corresponding to the light emitting diode LED_R is 5V. The threshold voltage of the light emitting diode LED_R is 1.8V. The voltage difference Vt1_R between two ends of the driving transistor T1_R corresponding to the light emitting diode LED_R is 3.2V. The ratio of the power consumption PTFT_R (e.g., equal to I_R*Vt1_R) of the driving transistor T1_R to the total power consumption Ptotal_R (e.g., equal to I_R*VDD_R) of the sub-pixel circuit 106_R is 64%.

The supply voltage VDD_G corresponding to the light emitting diode LED_G is 5V. The threshold voltage of the light emitting diode LED_G is 2.2V. The voltage difference Vt1_G between two ends of the driving transistor T1_G corresponding to the light emitting diode LED_G is 2.8V. The ratio of the power consumption PTFT_G (e.g., equal to I_G*Vt1_G) of the driving transistor T1_G to the total power consumption Ptotal_G (e.g., equal to I_G*VDD_G) of the sub-pixel circuit 106_G is 56%.

The supply voltage VDD_B corresponding to the light emitting diode LED_B is 5V. The threshold voltage of the light emitting diode LED_B is 2.7V. The voltage difference Vt1_B between two ends of the driving transistor T1_B corresponding to the light emitting diode LED_B is 2.3V. The ratio of the power consumption PTFT_B (e.g., equal to I_B*Vt1_B) of the driving transistor T1_B to the total power consumption Ptotal_B (e.g., equal to I_B*VDD_B) of the sub-pixel circuit 106_B is 46%.

Table 2 illustrates one embodiment of the present disclosure that the supply voltages VDD_R, VDD_G, VDD_B are different from each other.

| | | Threshold | | |
|---|---|---|---|---|
| | VDD | voltage | Vt1 | PTFT/Ptotal |
| LED_R | 4 V | 1.8 V | 2.2 V | 55% |
| LED_G | 4.5 V | 2.2 V | 2.3 V | 51% |
| LED_B | 5 V | 2.7 V | 2.3 V | 46% |

In this embodiment, the supply voltage VDD_R corresponding to the light emitting diode LED_R is 4V. The threshold voltage of the light emitting diode LED_R is 1.8V. The voltage difference Vt1_R between two ends of the driving transistor T1_R corresponding to the light emitting diode LED_R is 2.2V. The ratio of the power consumption PTFT_R (e.g., equal to I_R*Vt1_R) of the driving transistor T1_R to the total power consumption Ptotal_R (e.g., equal to I_R*VDD_R) of the sub-pixel circuit 106_R is 55%.

The supply voltage VDD_G corresponding to the light emitting diode LED_G is 4.5V. The threshold voltage of the light emitting diode LED_G is 2.2V. The voltage difference Vt1_G between two ends of the driving transistor T1_G corresponding to the light emitting diode LED_G is 2.3V. The ratio of the power consumption PTFT_G (e.g., equal to I_G*Vt1_G) of the driving transistor T1_G to the total power consumption Ptotal_G (e.g., equal to I_G*VDD_G) of the sub-pixel circuit 106_G is 51%.

The supply voltage VDD_B corresponding to the light emitting diode LED_B is 5V. The threshold voltage of the light emitting diode LED_B is 2.7V. The voltage difference Vt1_B between two ends of the driving transistor T1_B corresponding to the light emitting diode LED_B is 2.3V. The ratio of the power consumption PTFT_B (e.g., equal to I_B*Vt1_B) of the driving transistor T1_B to the total power consumption Ptotal_B (e.g., equal to I_B*VDD_B) of the sub-pixel circuit 106_B is 46%.

According to Table 1 and Table 2, when the supply voltage VDD_R is lower than the supply voltage VDD_G, and the supply voltage VDD_G is lower than the supply voltage VDD_B to reduce the voltage differences Vt1_R, Vt1_G between two ends of the driving transistors T1_R, T1_G, the power consumption of the driving transistor T1_R, T1_G can be decreased.

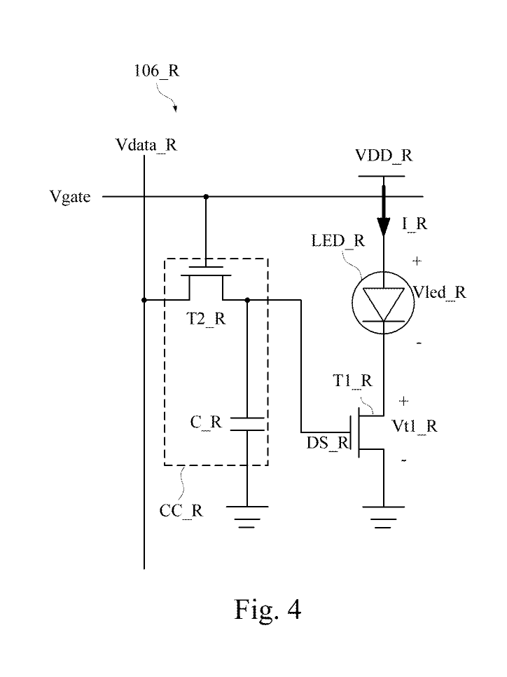

FIG. 4 illustrates details of the control circuit CC_R in accordance with another embodiment of the present disclosure. In this embodiment, the control circuit CC_R includes a transistor T2_R and a capacitor C_R. One end of the transistor T2_R is electrically connected to the gate end of the transistor T1_R. Another end of the transistor T2_R is configured to receive the data voltage Vdata_R. The gate end of the transistor T2_R is configured to receive the scan signal Vgate. The capacitor C_R is electrically connected between the transistor T2_R and the ground.

In some embodiments, the configurations of the control circuits CC_G, CC_B may be similar to the configuration of the control circuit CC_R, and a description in this regard will not be repeated herein.

It should be noted that the configurations of the control circuits CC_R, CC_G, CC_B is for illustration purposes, and other configurations are within the contemplated scope of the present disclosure.

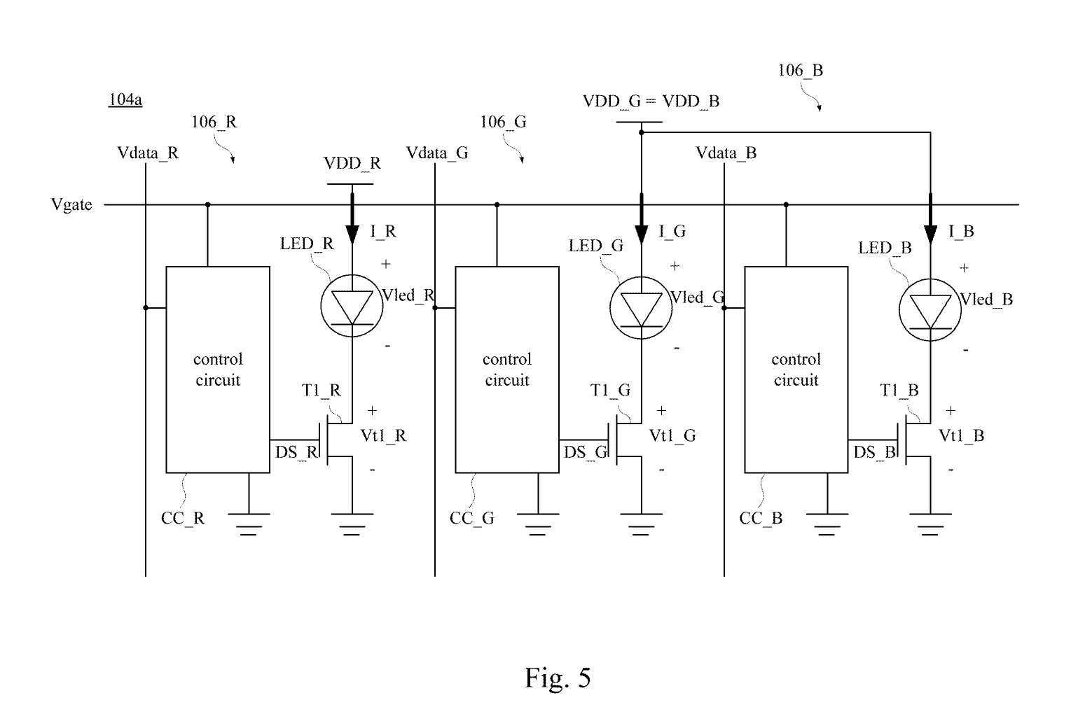

FIG. 5 is a schematic diagram of a pixel circuit 104a in accordance with another embodiment of the present disclosure. In one embodiment, the pixel circuit 104a can be used to substitute for the pixel circuit 104 shown in FIG. 1. The pixel circuit 104a is substantially identical to the pixel circuit 104. Aspects of the pixel circuit 104a that are similar to those of the previous embodiment will not be repeated herein.

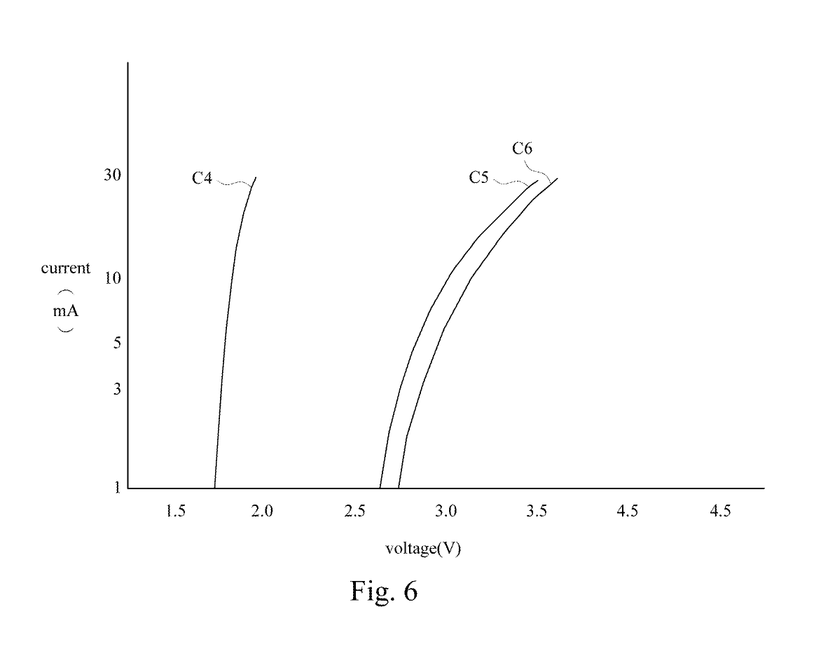

In this embodiment, two of the threshold voltages of the light emitting diodes LED_R, LED_G, LED_B are substantially equal, and are different from the rest one of the threshold voltages of the light emitting diodes LED_R, LED_G, LED_B. For example, FIG. 6 illustrates relationships between the forward voltages and the driving currents I_R, I_G, I_B of different light emitting diodes LED_R, LED_G, LED_B in accordance with one embodiment of the present disclosure. Curve C4 indicates the relationship between the forward voltage Vled_R and the driving current I_R, Curve C5 indicates the relationship between the forward voltage Vled_G and the driving current I_G, and Curve C6 indicates the relationship between the forward voltage Vled_B and the driving current I_B. Curves C5, C6 are close to each other. That is, the threshold voltages of the light emitting diodes LED_G, LED_B are substantially equal.

In this embodiment, the supply voltage VDD_G is equal to the supply voltage VDD_B. In this embodiment, the light emitting diodes LED_G, LED_B are connected to an identical voltage supply that provides the supply voltages VDD_G, VDD_B. The supply voltage VDD_R is different from the supply voltages VDD_G, VDD_B. With such a configuration, the power loss on the driving transistors T1_R, T1_G can be reduced. In addition, compared to the embodiment shown in FIG. 2, in this embodiment, the area requirement for different power sources for providing different supply voltages can also be reduced.

Table 3 illustrates one embodiment of the present disclosure that the threshold voltages of the light emitting diodes LED_G, LED_B are substantially equal, and the supply voltages VDD_G, VDD_B are identical and are different from the supply voltages VDD_R.

| | | Threshold | | |
|---|---|---|---|---|
| | VDD | voltage | Vt1 | PTFT/Ptotal |
| LED_R | 4 V | 1.8 V | 2.2 V | 55% |
| LED_G | 5 V | 2.6 V | 2.4 V | 48% |
| LED_B | 5 V | 2.7 V | 2.3 V | 46% |

In this embodiment, the supply voltage VDD_R corresponding to the light emitting diode LED_R is 4V. The threshold voltage of the light emitting diode LED_R is 1.8V. The voltage difference Vt1_R between two ends of the driving transistor T1_R corresponding to the light emitting diode LED_R is 2.2V. The ratio of the power consumption PTFT_R (e.g., equal to I_R*Vt1_R) of the driving transistor T1_R to the total power consumption Ptotal_R (e.g., equal to I_R*VDD_R) of the sub-pixel circuit 106_R is 55%.

The supply voltage VDD_G corresponding to the light emitting diode LED_G is 5V. The threshold voltage of the light emitting diode LED_G is 2.6V. The voltage difference Vt1_G between two ends of the driving transistor T1_G corresponding to the light emitting diode LED_G is 2.4V. The ratio of the power consumption PTFT_G (e.g., equal to I_G*Vt1_G) of the driving transistor T1_G to the total power consumption Ptotal_G (e.g., equal to I_G*VDD_G) of the sub-pixel circuit 106_G is 48%.

The supply voltage VDD_B corresponding to the light emitting diode LED_B is 5V. The threshold voltage of the light emitting diode LED_B is 2.7V. The voltage difference Vt1_B between two ends of the driving transistor T1_B corresponding to the light emitting diode LED_B is 2.3V. The ratio of the power consumption PTFT_B (e.g., equal to I_B*Vt1_B) of the driving transistor T1_B to the total power consumption Ptotal_B (e.g., equal to I_B*VDD_B) of the sub-pixel circuit 106_B is 46%.

According to Table 3, when the threshold voltage of the light emitting diode LED_G substantially equal to the threshold voltage of the light emitting diode LED_B, the supply voltage VDD_R is lower than the supply voltage VDD_G, and the supply voltage VDD_G is equal to the supply voltage VDD_B to reduce the voltage difference Vt1_R between two ends of the driving transistor T1_R, the power consumption of the driving transistor T1_R can be decreased.

In addition, with such configuration, the circuit for providing the supply voltage VDD_B can be omitted, and the cost for manufacturing the display device containing the pixel circuit 104a can be reduced.

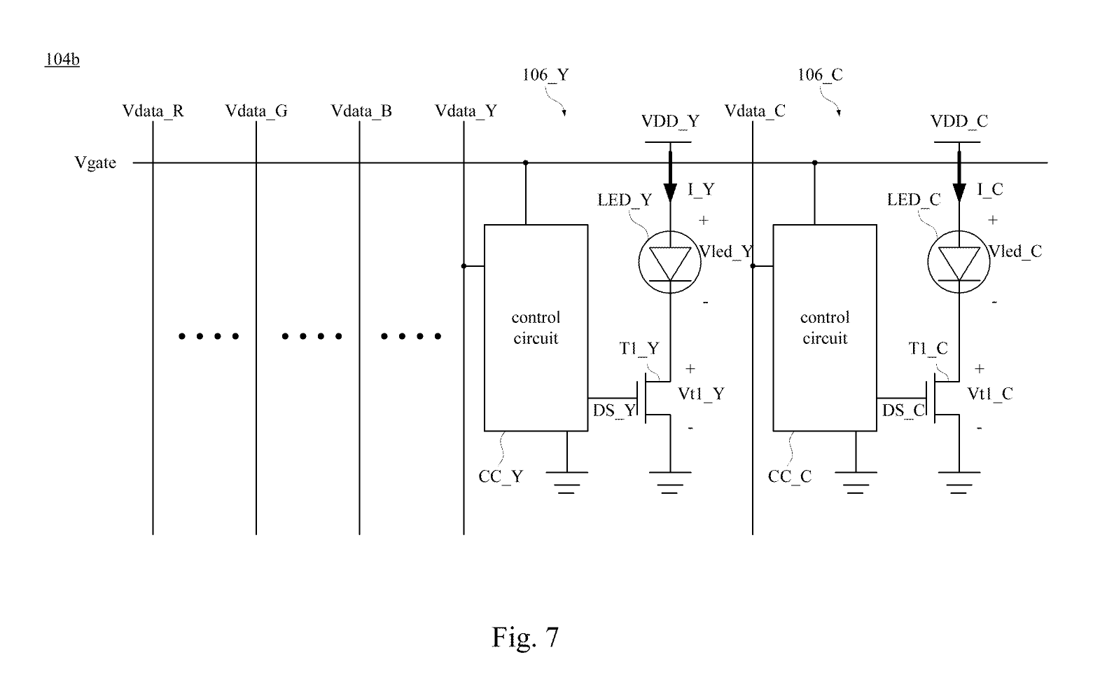

FIG. 7 is a schematic diagram of a pixel circuit 104b in accordance with another embodiment of the present disclosure. In one embodiment, the pixel circuit 104b can be used to substitute for the pixel circuit 104 shown in FIG. 1. The pixel circuit 104b is substantially identical to the pixel circuit 104. Aspects of the pixel circuit 104b that are similar to those of the previous embodiment will not be repeated herein.

In this embodiment, in addition to the sub-pixel circuits 106_R, 106_G, 106_B, the pixel circuit 104b further includes at least one of sub-pixel circuits 106_Y, 106_C. In this embodiment, the configurations of the sub-pixel circuits 106_Y, 106_C are similar to the configurations of the sub-pixel circuits 106_R, 106_G, 106_B. Therefore, aspects of the sub-pixel circuits 106_Y, 106_C that are similar to those of the sub-pixel circuits 106_R, 106_G, 106_B will not be repeated herein.

In one embodiment, the light emitting diode LED_Y is a yellow light emitting diode. In one embodiment, the light emitting diode LED_C is a cyan light emitting diode.

Under a case that the pixel circuit 104b has the light emitting diodes LED_R, LED_G, LED_B, LED_Y, the supply voltages VDD_R, VDD_G, VDD_Y are identical, and different from the supply voltage VDD_B. In one embodiment of such a case, the light emitting diodes LED_R, LED_G, LED_Y are connected to an identical voltage supply that provides the supply voltages VDD_R, VDD_G, VDD_Y.

Under a case that the pixel circuit 104b has the light emitting diodes LED_R, LED_G, LED_B, LED_C, the supply voltages VDD_R, VDD_G are identical, the supply voltages VDD_B, VDD_C are identical, and the supply voltages VDD_R, VDD_G are different from the supply voltages VDD_B, VDD_C. In one embodiment of such a case, the light emitting diodes LED_R, LED_G are connected to an identical voltage supply that provides the supply voltages VDD_R, VDD_G, and the light emitting diodes LED_B, LED_C are connected to another voltage supply that provides the supply voltages VDD_B, VDD_C.

Under a case that the pixel circuit 104b has the light emitting diodes LED_R, LED_G, LED_B, LED_C, LED_Y, the supply voltages VDD_R, VDD_G, VDD_Y are identical, the supply voltages VDD_B, VDD_C are identical, and the supply voltages VDD_R, VDD_G, VDD_Y are different from the supply voltages VDD_B, VDD_C. In one embodiment of such a case, the light emitting diodes LED_R, LED_G, LED_Y are connected to an identical voltage supply that provides the supply voltages VDD_R, VDD_G, VDD_Y, and the light emitting diodes LED_B, LED_C are connected to another voltage supply that provides the supply voltages VDD_B, VDD_C.

With such a configuration, the power consumption of the display device 100 can be reduced.

Although the present invention has been described in considerable detail with reference to certain embodiments thereof, other embodiments are possible. Therefore, the scope of the appended claims should not be limited to the description of the embodiments contained herein.

What is claimed is:

1. A light emitting circuit comprising:
a first light emitting diode;
a first driving transistor serially and electrically connected with a first voltage supply having a first supply voltage and the first light emitting diode;
a first control circuit electrically connected to the first driving transistor, configured to drive the first driving transistor according to a first data voltage and a scan signal;
a second light emitting diode;
a second driving transistor serially and electrically connected with a second voltage supply having a second supply voltage and the second light emitting diode;
a second control circuit electrically connected to the second driving transistor, configured to drive the second driving transistor according to a second data voltage and the scan signal;
a third light emitting diode;
a third driving transistor serially and electrically connected with a third voltage supply having a third supply voltage and the third light emitting diode; and
a third control circuit electrically connected to the third driving transistor, configured to drive the third driving transistor according to a third data voltage and the scan signal;
wherein at least two of the first supply voltage, the second supply voltage, and the third supply voltage are different from each other.

2. The light emitting circuit as claimed in claim 1, wherein at least two of threshold voltages of the first light emitting diode, the second light emitting diode, and the third light emitting diode are different from each other.

3. The light emitting circuit as claimed in claim 1, wherein the first light emitting diode is a red light emitting diode, the second light emitting diode is a green light emitting diode, the third light emitting diode is a blue light emitting diode, the second supply voltage is greater than the first supply voltage, and the third supply voltage is greater than the second supply voltage.

4. The light emitting circuit as claimed in claim 3, wherein the threshold voltage of the second light emitting diode is greater than the threshold voltage of the first light emitting diode, and the threshold voltage of the third light emitting diode is greater than the threshold voltage of the second light emitting diode.

5. The light emitting circuit as claimed in claim 1, wherein the first light emitting diode is a red light emitting diode, the second light emitting diode is a green light emitting diode, the third light emitting diode is a blue light emitting diode, the second supply voltage is greater than the first supply voltage, and the third supply voltage is equal to the second supply voltage.

6. The light emitting circuit as claimed in claim 5, wherein the threshold voltage of the second light emitting diode is greater than the threshold voltage of the first light emitting diode, and the threshold voltage of the third light emitting diode is substantially equal to the threshold voltage of the second light emitting diode.

7. A display device comprising:
a plurality of scan lines;
a plurality of data lines; and
a plurality of pixels electrically connected to the scan lines and the data lines, wherein each of the pixels comprises:
a first light emitting diode;
a first driving transistor serially and electrically connected with a first voltage supply having a first supply voltage and the first light emitting diode;
a first control circuit electrically connected to the first driving transistor, configured to drive the first driving transistor according to a first data voltage from a first data line of the data lines and a scan signal from one of the scan lines to drive the first driving circuit;
a second light emitting diode;
a second driving transistor serially and electrically connected with a second voltage supply having a second supply voltage and the second light emitting diode;
a second control circuit electrically connected to the second driving transistor, configured to drive the second driving transistor according to a second data voltage from a second data line of the data lines and the scan signal from the one of the scan lines to drive the second driving circuit;
a third light emitting diode;
a third driving transistor serially and electrically connected with a third voltage supply having a third supply voltage and the third light emitting diode; and
a third control circuit electrically connected to the third driving transistor, configured to drive the third driving transistor according to a third data voltage from a third data line of the data lines and the scan signal from the one of the scan lines to drive the third driving circuit;
wherein at least two of the first supply voltage, the second supply voltage, and the third supply voltage are different from each other.

8. The display panel as claimed in claim 7, wherein at least two of threshold voltages of the first light emitting diode, the second light emitting diode, and the third light emitting diode are different from each other.

9. The display panel as claimed in claim 7, wherein the first light emitting diode is a red light emitting diode, the second light emitting diode is a green light emitting diode, the third light emitting diode is a blue light emitting diode, the second supply voltage is greater than the first supply voltage, and the third supply voltage is greater than the second supply voltage.

10. The display panel as claimed in claim 9, wherein the threshold voltage of the second light emitting diode is greater than the threshold voltage of the first light emitting diode, and the threshold voltage of the third light emitting diode is greater than the threshold voltage of the second light emitting diode.

11. The display panel as claimed in claim 7, wherein the first light emitting diode is a red light emitting diode, the second light emitting diode is a green light emitting diode, the third light emitting diode is a blue light emitting diode, the second supply voltage is greater than the first supply voltage, and the third supply voltage is equal to the second supply voltage.

12. The display panel as claimed in claim 7, wherein the threshold voltage of the second light emitting diode is greater than the threshold voltage of the first light emitting diode, and the threshold voltage of the third light emitting diode is substantially equal to the threshold voltage of the second light emitting diode.

13. A pixel comprising:
a first driving transistor configured to drive a first light emitting diode according to a first driving signal and a first supply voltage from a first voltage supply;
a first control circuit configured to generate the first driving signal according to a first data voltage and a scan signal;
a second driving transistor configured to drive a second light emitting diode according to a second driving signal and a second supply voltage from a second voltage supply; and
a second control circuit configured to generate the second driving signal according to a second data voltage and the scan signal;
wherein the first supply voltage, and the second supply voltage are different from each other.

14. The pixel as claimed in claim 13, wherein threshold voltages of the first light emitting diode and the second light emitting diode are different.

15. The pixel as claimed in claim 13, wherein the first light emitting diode is a red light emitting diode, the second light emitting diode is a green light emitting diode or a blue light emitting diode, and the second supply voltage is greater than the first supply voltage.

16. The pixel as claimed in claim 13, wherein the first light emitting diode is a green light emitting diode, the second light emitting diode is a blue light emitting diode, and the second supply voltage is greater than the first supply voltage.

17. The pixel as claimed in claim 13 further comprising:
a third driving transistor configured to drive a third light emitting diode according to a third driving signal and a third supply voltage from a third voltage supply; and
a third control circuit configured to generate the third driving signal according to a third data voltage and the scan signal;
wherein the third supply voltage is different from the first supply voltage and the second supply voltage.

18. The pixel as claimed in claim 13 further comprising:
a third driving transistor configured to drive a third light emitting diode according to a third driving signal and the second supply voltage from the second voltage supply; and
a third control circuit configured to generate the third driving signal according to a third data voltage and the scan signal.

19. The pixel as claimed in claim 13 further comprising:
a fourth driving transistor configured to drive a fourth light emitting diode according to a fourth driving signal and the first supply voltage from the first voltage supply; and
a fourth control circuit configured to generate the fourth driving signal according to a fourth data voltage and the scan signal.

20. The pixel as claimed in claim 13 further comprising:
a fourth driving transistor configured to drive a fourth light emitting diode according to a fourth driving signal and the second supply voltage from the second voltage supply; and
a fourth control circuit configured to generate the fourth driving signal according to a fourth data voltage and the scan signal.

21. The pixel as claimed in claim 13 further comprising:
a fifth driving transistor configured to drive a fifth light emitting diode according to a fifth driving signal and the first supply voltage from the first voltage supply; and
a fifth control circuit configured to generate the fifth driving signal according to a fifth data voltage and the scan signal.

22. The pixel as claimed in claim 13 further comprising:
a fifth driving transistor configured to drive a fifth light emitting diode according to a fifth driving signal and the second supply voltage from the second voltage supply; and
a fifth control circuit configured to generate the fifth driving signal according to a fifth data voltage and the scan signal.
